(19) United States
(12) Patent Application Publication
(10) Pub. No.: US 2026/0187385 A1
(43) Pub. Date: Jul. 2, 2026

(54) GENERATION APPARATUS, GENERATION METHOD, AND PROGRAM

(71) Applicant: NTT, Inc., Tokyo (JP)

(72) Inventors: Katsuki CHOSA, Tokyo (JP); Makoto MORISHITA, Tokyo (JP)

(21) Appl. No.: 18/857,294

(22) PCT Filed: Apr. 19, 2022
(86) PCT No.: PCT/JP2022/018217

§ 371 Date: Oct. 16, 2024

(51) Int. Cl. G06F 40/58; G06F 40/284

(52) U.S. Cl. CPC G06F 40/58; G06F 40/284

(57) ABSTRACT

A generation apparatus that generates an output sequence that is a sequence of another piece of information from an input sequence that is a sequence of information includes: a generation unit that generates the output sequence from the input sequence and constraint information given, by using a sequence conversion model; and a correction unit that corrects the output sequence obtained by the generation unit so that the output sequence includes the constraint information.

### TECHNICAL FIELD

The present invention relates to the technical field of machine translation.

### BACKGROUND ART

Translation with a constraint that all specified phrases are included when a sentence in a certain domain is converted into another domain (for example, another language) is referred to as lexically constrained machine translation. The lexically constrained machine translation is a key technology in the translation of patent/legal/technical documents and the like where consistency is required, since lexically constrained machine translation can unify translations for specific words.

### CITATION LIST

### Non Patent Literature

Non Patent Literature 1: Post and Vilar (2018) proposed a grid beam search decoding. They guarantee to satisfy all constraints.

### SUMMARY OF INVENTION

### Technical Problem

There are various technologies such as the technology disclosed in Non Patent Literature 1 as a conventional technology of lexically constrained machine translation. In any of these conventional technologies, there is a possibility that information is missing from the original sequence at the time of inputting the sequence into the machine translation model due to pre-processing of the sequence to be converted or the like. Therefore, there is a problem that the constraint may not be completely satisfied in the output sequence. Such a problem is a problem that can occur in general sequence conversion (for example, summary task) not limited to machine translation.

The present invention has been made in view of the above points, and an object of the present invention is to provide a technology that enables all the given constraint vocabularies to be included in an output sequence in sequence conversion with vocabulary constraints.

### Solution to Problem

According to the disclosed technology, provided is a generation apparatus that generates an output sequence that is a sequence of another piece of information from an input sequence that is a sequence of information, the generation apparatus including:
a generation unit that generates the output sequence from the input sequence and constraint information given, by using a sequence conversion model; and
a correction unit that corrects the output sequence obtained by the generation unit so that the output sequence includes the constraint information.

### Advantageous Effects of Invention

According to the disclosed technology, in sequence conversion with a constraint vocabulary, all the given constraint vocabularies can be included in the output sequence.

### BRIEF DESCRIPTION OF DRAWINGS

FIG. 1 is a diagram illustrating an example of lexically constrained machine translation.

FIG. 2 is a diagram illustrating a configuration example of a learning device 100 and a generation apparatus 200.

FIG. 3 is a diagram illustrating a configuration example of the generation apparatus 200.

FIG. 4 is a diagram illustrating a configuration example of the generation apparatus 200.

FIG. 5 is a diagram illustrating a flow of operation of the learning device 100.

FIG. 6 is a diagram illustrating a flow of operation of the generation apparatus 200.

FIG. 7 is a diagram illustrating an example of a machine translation model.

FIG. 8 is a diagram illustrating embeddings of inputs in a sequence conversion unit 230.

FIG. 9 is a diagram illustrating a processing procedure of a correction unit 250.

FIG. 10 is a diagram illustrating a processing procedure of the correction unit 250.

FIG. 11 is a diagram illustrating detailed settings and hyperparameters serving as a base in each setting used in an experiment.

FIG. 12 is a diagram illustrating an evaluation result of each setting.

FIG. 13 is a diagram illustrating an example of a translation sentence of a proposed system.

FIG. 14 is a diagram illustrating BLEU scores when various beam sizes are used.

FIG. 15 is a diagram illustrating a hardware configuration example of a device.

### DESCRIPTION OF EMBODIMENTS

Hereinafter, an embodiment of the present invention (present embodiment) will be described with reference to the drawings. The embodiment described below is merely an example, and embodiments to which the present invention is applied are not limited to the following embodiment.

In the embodiment described below, an example in which the present invention is applied to machine translation is illustrated, but the present invention can be applied to sequence conversion in any field as long as the sequence conversion uses a sequence conversion model such as an encoder-decoder model. For example, the present invention can also be used for a summary task, a speech sentence generation task, a task of attaching an explanatory sentence to an image, and the like.

In the embodiment described below, the unit of translation is a sentence as an example, but the unit of translation may be any unit.

Each of the generation apparatuses 200 described below provides a specific improvement over the conventional technology in which constrained sequence conversion is performed, and indicates improvement in the technical field related to constrained sequence conversion.

### (Regarding Problems)

Prior to describing a configuration according to the present embodiment in detail, first, a conventional technology and a problem thereof will be described. The following description of the problem is not a publicly known technology. The problem described below is a problem related to the technology of the embodiment.

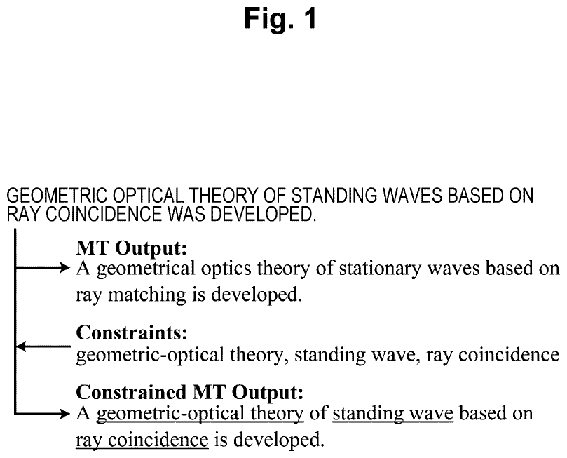

As already described, when a sentence in a certain domain is converted into another domain (for example, another language), a sentence having a constraint that all specified phrases are included is referred to as a lexically constrained machine translation. For reference, FIG. 1 illustrates an example of input and output in lexically constrained machine translation.

In the example of FIG. 1, machine translation (MT output), constraints, and constrained machine translation (constrained MT output) are illustrated for a source language sentence “A geometric optical theory of standing waves based on ray coincidence was developed.”. Underlined parts indicate the constraint vocabulary.

### <Problem 1>

As a conventional technology of lexically constrained machine translation, a reference document “Chen et al. (2020) proposed a method that augment the input of the translation model.” discloses a method of connecting and inputting a source language sentence and a constraint vocabulary. However, such a conventional technology cannot guarantee that all the constraints are satisfied.

### <Problem 2>

Non Patent Literature 1: “Post and Vilar (2018) proposed a grid beam search decoding. They guarantee to satisfy all constraints.” discloses a technology of lexically constrained machine translation using grid beam search in which beam search for searching for a preferable translation result using an output of a decoder of a machine translation model is improved. The use of grid beam search makes it possible to satisfy the constraints, but there is a problem that the search time increases and translation accuracy deteriorates when the constraint vocabulary is long.

That is, in the technology disclosed in Non Patent Literature 1, a large beam size (for example, a size larger than 60) is required in order to include all the constraint vocabularies in the output sequence, and the search time increases. The translation accuracy is also low.

### <Problem 3>

In conventional lexically constrained machine translation, there is a case where information regarding a blank or a multibyte character of an input sequence is missing during processing in a preprocessing stage, or, because a partial character string that cannot be handled by a machine translation model exists in an input sequence, the character string is replaced with a special token.

In such a case, using an approach that is guaranteed to satisfy the lexical constraints does not result in a state where the output sequence includes all the given constraint vocabularies.

### OVERVIEW OF EMBODIMENT

### Overview of Embodiment Corresponding to Problems 1 and 2

A cause of the problem of the technology disclosed in Non Patent Literature 1 is considered to be that the information on the constraint vocabulary is not input to the machine translation model, and thus the scores for the vocabularies cannot be set high at an appropriate position.

Therefore, the generation apparatus 200 according to the present embodiment inputs a series obtained by connecting a source language sentence and a constraint vocabulary to a machine translation model, and applies grid beam search to an output (probability of each word) from the machine translation model for the input. As a result, the search time can be shortened. According to the experimental result, the translation accuracy can be improved, and the processing speed can also be improved.

### Overview of Embodiment Corresponding to Problem 3

In order to solve the problem that the constraint is not completely satisfied because the information in the series is missing when the series is input to the machine translation model, the generation apparatus 200 according to the present embodiment corrects the output sentence with reference to the notation information of the original input data before the input data is processed. As a result, all the given constraint phrases are included in the output sequence.

### Device Configuration Example

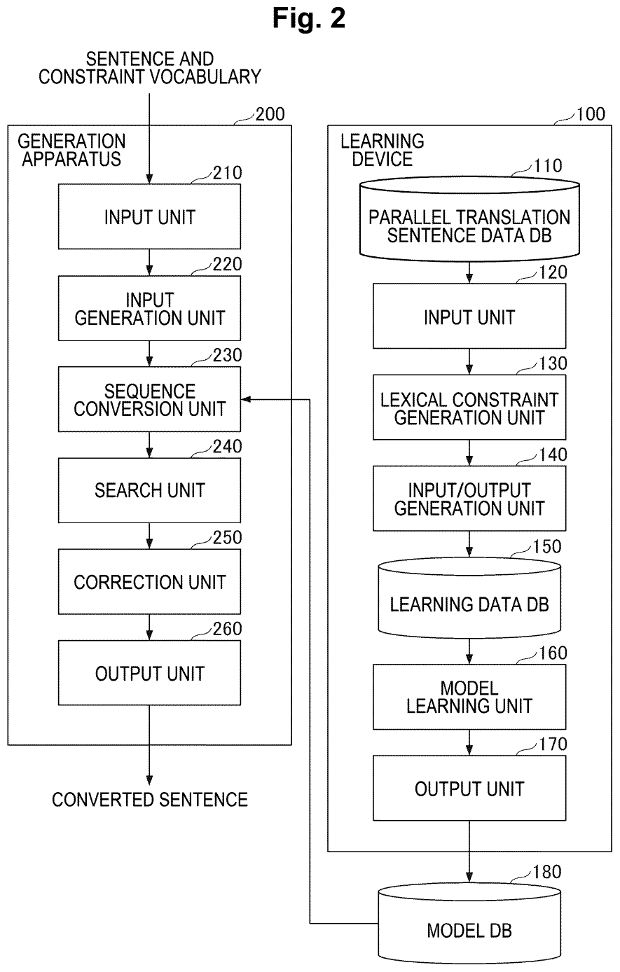

FIG. 2 illustrates configuration examples of the learning device 100 and the generation apparatus 200 according to the present embodiment. As illustrated in FIG. 2, the learning device 100 includes a parallel translation sentence data DB 110, an input unit 120, a lexical constraint generation unit 130, an input/output generation unit 140, a learning data DB 150, a model learning unit 160, and an output unit 170. The parallel translation sentence data DB 110 and the learning data DB 150 may be provided outside the learning device 100.

The output unit 170 of the learning device 100 outputs the lexically constrained machine translation model (hereinafter, referred to as a machine translation model), which is stored in the model DB 180. The machine translation model is read from the model DB 180 by the generation apparatus 200 and used for machine translation by the generation apparatus 200. The actual state of the “machine translation model” stored in the DB is data including functions, weight parameters, and the like constituting the neural network.

As illustrated in FIG. 2, the generation apparatus 200 includes an input unit 210, an input generation unit 220, a sequence conversion unit 230, a search unit 240, a correction unit 250, and an output unit 260.

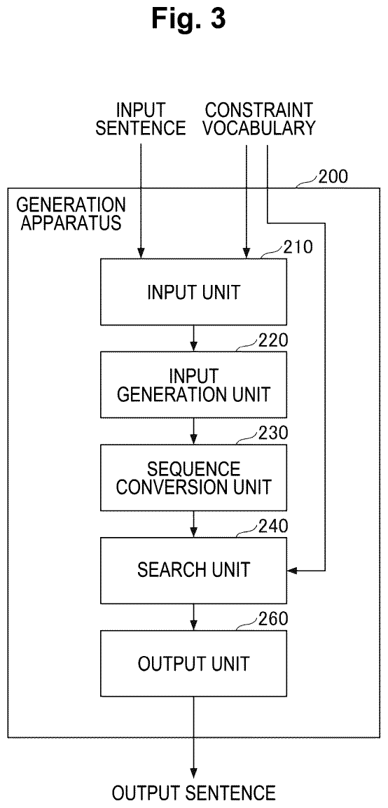

As illustrated in FIG. 3, the generation apparatus 200 may employ a configuration including the input unit 210, the input generation unit 220, the sequence conversion unit 230, the search unit 240, and the output unit 260 without including the correction unit 250. In FIGS. 2 and 3, the “sequence conversion unit 230+search unit 240” may be referred to as a search unit.

The generation apparatus 200 illustrated in FIG. 3 is an example of a generation apparatus that generates an output sequence that is a sequence of another piece of information from an input sequence that is a sequence of information, the generation apparatus including: an input generation unit that generates an input sequence with constraint information on the basis of the input sequence and constraint information; and a sequence conversion unit that generates output information by inputting the input sequence with constraint information to a sequence conversion model; and a search unit that generates the output sequence by performing a constrained search using the output information such that the output sequence includes the constraint information.

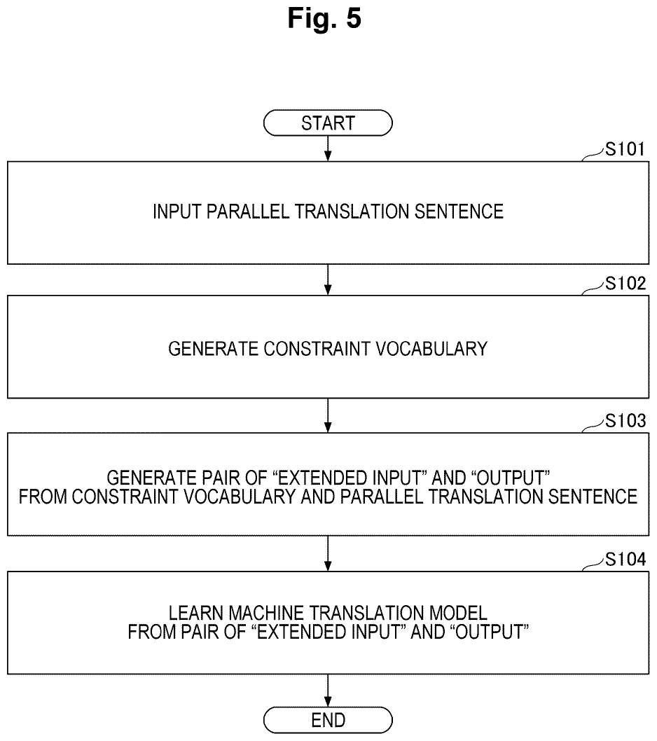

All (or a part of) the processing in the generation apparatus described above may be performed by a neural network. The parameters of the neural network have been learned in advance. The learning for learning the parameter may be performed by the learning device 100 according to the procedure of FIG. 5.

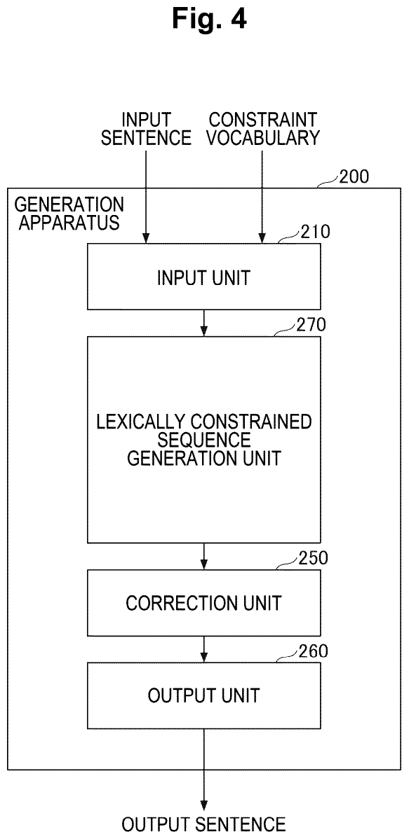

As illustrated in FIG. 4, a configuration including the input unit 210, a lexically constrained sequence generation unit 270, the correction unit 250, and the output unit 260 may be adopted as the generation apparatus 200 of the modification. The lexically constrained sequence generation unit 270 may be the “input generation unit 220+sequence conversion unit 230+search unit 240” illustrated in FIG. 2, may be a lexically constrained machine translation model (for example, the model disclosed in Non Patent Literature 1) in the conventional technology, or may be a model other than these. The lexically constrained sequence generation unit may be referred to as a “generation unit”.

The generation apparatus 200 illustrated in FIG. 4 is an example of a generation apparatus that generates an output sequence that is a sequence of another piece of information from an input sequence that is a sequence of information, the generation apparatus including: a generation unit that generates the output sequence from the input sequence and constraint information given, by using a sequence conversion model; and a correction unit that corrects the output sequence obtained by the generation unit so that the output sequence includes the constraint information.

The generation unit described above may include a neural network, and the sequence conversion model may be a learned parameter of the neural network. The learning for learning the parameter may be performed by the learning device 100 according to the procedure of FIG. 5.

The function/operation of each unit of the learning device 100 and the generation apparatus 200 described above will be described later.

### (Overall Operation Flow)

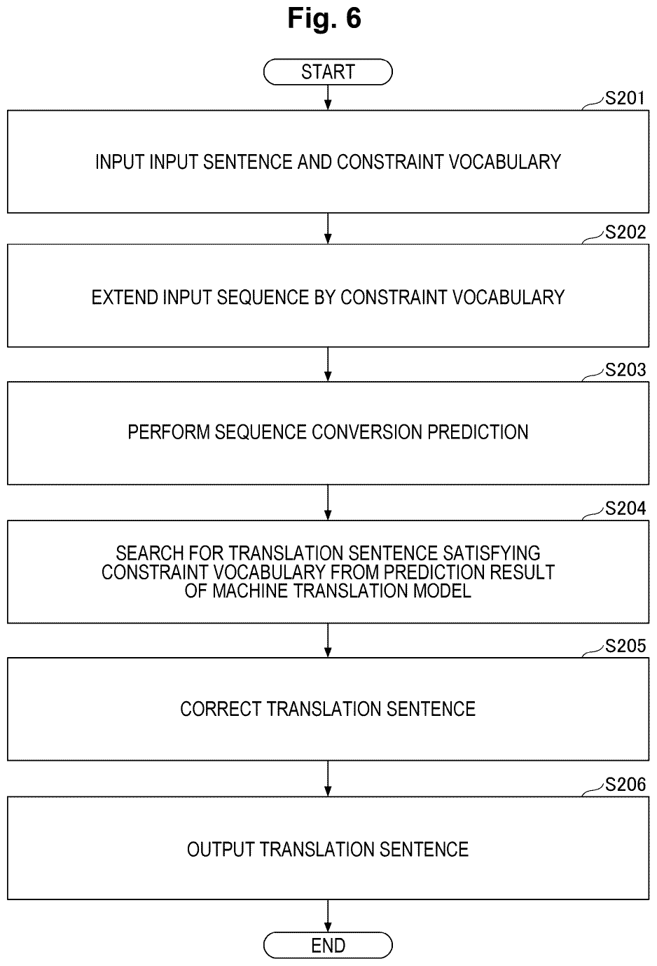

The flow of the entire operation in the device configuration illustrated in FIG. 2 will be described with reference to FIGS. 5 and 6. As for the parallel translation sentence appearing below, a parallel translation sentence in which both the source language sentence and the target language sentence are divided into words in advance is read. However, in a case where the division processing is not performed, the division processing may be performed in the input/output generation unit 140 or the like. Any division processing method or division unit may be used. This division processing may be referred to as tokenizing.

A division unit obtained by the division processing may be referred to as a token. The token may be a word, may be obtained by further dividing a word, or may be a character obtained by dividing in units of characters. The tokenizing refers to the division processing itself, and the tokenizer refers to a function (software or the like) of performing the division processing.

### <Flow of Learning>

A flow of an operation of the learning device 100 will be described with reference to FIG. 5. It is assumed that parallel translation sentence data is stored in advance in the parallel translation sentence data DB 110. In S101, the input unit 120 reads the parallel translation sentence from the parallel translation sentence data DB 110, and inputs the read parallel translation sentence to the lexical constraint generation unit 130 and the input/output generation unit 140.

In S102, the lexical constraint generation unit 130 generates a constraint vocabulary from the parallel translation sentence, and passes the constraint vocabulary to the input/output generation unit 140. In S103, the input/output generation unit 140 generates a pair of “extended input” and “output” from the constraint vocabulary and the parallel translation sentence, and stores the generated pair of data in the learning data DB 150 as learning data of the lexically constrained machine translation.

In S104, the model learning unit 160 reads learning data including a pair of “extended input” and “output” from the learning data DB 150, and learns the lexically constrained machine translation model using the learning data. The learned machine translation model is stored in the model DB 180 by the output unit 170.

### <Flow of Translation Execution>

Next, a flow of execution of lexically constrained machine translation by the generation apparatus 200 will be described with reference to FIG. 6. Here, it is assumed that the sequence conversion unit 230 reads the machine translation model from the model DB 180 and holds the machine translation model.

In S201, the input unit 210 inputs the input sentence to be translated and the constraint vocabulary, and passes the input sentence and the constraint vocabulary to the input generation unit 220. In S202, the input generation unit 220 extends the input sentence (input sequence) using the constraint vocabulary.

In S203, the sequence conversion unit 230 executes sequence conversion prediction by inputting the input sequence generated in S202 to the machine translation model. The output (prediction result) of the machine translation model is passed to the search unit 240.

In S204, the search unit 240 searches for a translation sentence that satisfies the constraint vocabulary from the prediction result by the machine translation model. The translation sentence obtained by the search is passed to the correction unit 250.

In S205, the correction unit 250 corrects the translation sentence, and delivers the corrected translation sentence to the output unit 260. In S206, the output unit 260 outputs the corrected translation sentence.

### (Regarding Machine Translation Model)

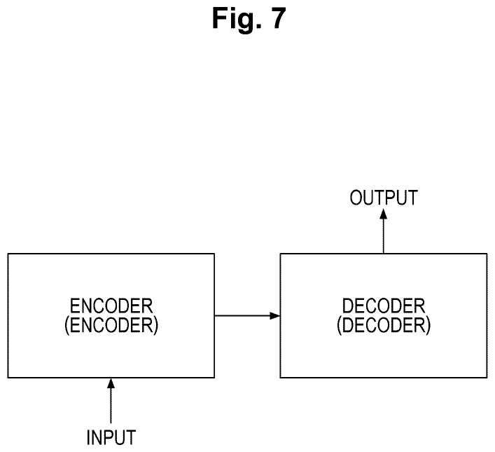

A machine translation model according to the present embodiment will be described. In the present embodiment, as illustrated in FIG. 7, a general encoder-decoder model (for example, transformer) including an encoder and a decoder is used. However, the present invention can be implemented by using a model other than the encoder-decoder model. The machine translation model is an example of a sequence conversion model.

### (Operation of Each Unit)

Hereinafter, the operation of each unit that executes processing in the device configuration illustrated in FIGS. 2 to 4 will be described. Those performing conventional general operations will be described only briefly. The input units 120 and 210 and the output units 170 and 260 are as described above.

### <Lexical Constraint Generation Unit 130 of Learning Device 100>

Since the parallel translation sentence data for learning does not have information on the constraint vocabulary, the lexical constraint generation unit 130 generates the constraint vocabulary for the parallel translation sentence with the parallel translation sentence (the source language sentence and the target language sentence) as an input.

Specifically, for example, the lexical constraint generation unit 130 samples the number k from 0 to 14 numbers, randomly extracts k words from the tokenized target language sentence, and uses the extracted words as the constraint vocabularies. The extracted words that appear consecutively are treated as one constraint.

### <Input Generation Unit 220 of Generation Apparatus 200>

The input generation unit 220 receives the source language sentence and the constraint vocabulary as inputs, and extends the source language sentence using the constraint vocabulary, thereby creating an input sequence to which information on the constraint vocabulary is added. The input generation unit 220 outputs the extended input sequence to the sequence conversion unit 230.

More specifically, the input generation unit 220 first performs pre-processing. The pre-processing may be referred to as tokenizing processing. In the pre-processing, processing of dividing the input sentence and constraint vocabulary into any processing units defined in advance is performed.

The input generation unit 220 couples (connects) the source language sentence X, which is an input sequence, and each constraint vocabulary Cᵢ via a character string indicating a special delimiter <sep> as described below, thereby creating an input sequence with the constraint vocabulary. <eos> is a character string indicating the end of the sentence.

[X, <sep>, C₁, <sep>, C₂, . . . , CN, <eos>]

Connecting the input sequence and the constraint vocabulary as described above to generate the input sequence with the constraint vocabulary is an example. The input sequence with the constraint vocabulary may be generated by any processing as long as the processing uses the input sequence and the constraint vocabulary.

### <Input/Output Generation Unit 140 of Learning Device 100>

Using the source language sentence of the parallel translation sentence and the generated constraint vocabulary, the input/output generation unit 140 performs the same processing as that of the input generation unit 220 of the generation apparatus 200 to generate an input sequence for learning. The output for learning uses the target language sentence of the parallel translation sentence.

That is, the input/output generation unit 140 outputs a pair of the extended input sequence and the target language sentence as learning data for lexically constrained machine translation.

### <Model Learning Unit 160 of Learning Device 100>

The model learning unit 160 calculates a loss between the output of the model for the input sequence and the target language sentence from the pair of the input sequence and the target language sentence of the lexically constrained machine translation learning data, and updates the parameters of the model so as to minimize the loss.

### <Sequence Conversion Unit 230 of Generation Apparatus 200>

The sequence conversion unit 230 generates a sentence using the extended input sequence as an input using the machine translation model. More specifically, the probability of each word in the set of words that can form the output sequence is output.

The sequence conversion unit 230 of the generation apparatus 200 changes the embedding vector representation in the embedding layer of the encoder in the machine translation model from the general embedding vector representation according to the extension of the input sequence. This processing is performed to distinguish the source language sentence and each constraint vocabulary.

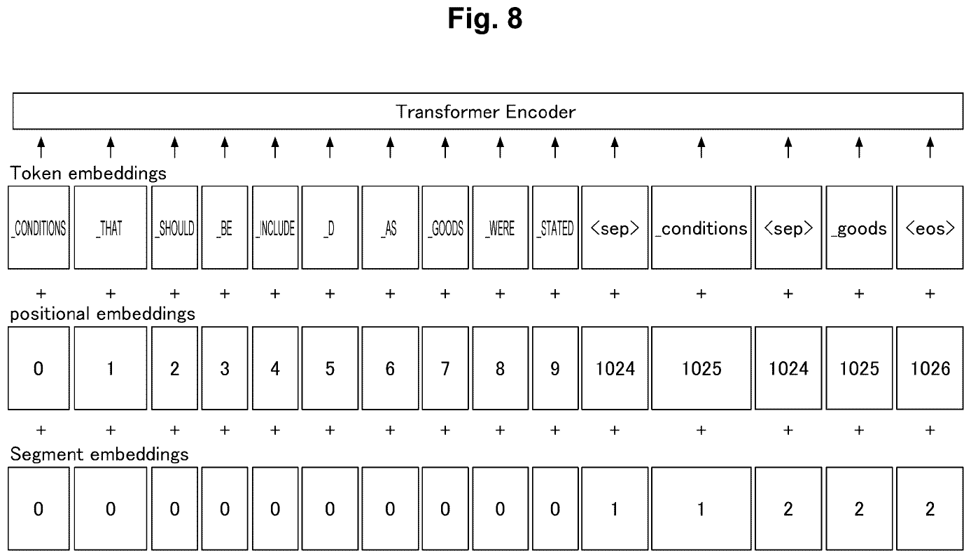

More specifically, the embedding vector representation generated by the sequence conversion unit 230 includes token embeddings, positional embeddings, and segment embeddings. FIG. 8 illustrates an example of token embeddings, positional embeddings, and segment embeddings converted by the sequence conversion unit 230.

The positional embedding is information indicating the position of each token, and the segment embedding is information for identifying each segment in the input sequence. The token embeddings, the positional embeddings, and the segment embeddings themselves are used in a general encoder-decoder model.

In order to avoid overlap between the source language sentence and the constraint vocabulary, the sequence conversion unit 230 starts the position of the constraint vocabulary from a value sufficiently larger than the source language sentence length. Different values are assigned as segments to the source language sentence and each constraint word/phrase.

### <Search Unit 240 of Generation Apparatus 200>

The search unit 240 uses the output probability of the decoder in the machine translation model to search for (an approximate solution of) an output sequence having the maximum generation probability when an input sequence is given. The search unit 240 can ensure that the output sequence satisfies all the constraint vocabularies by using a grid beam search method based on beam search, which is the same method as the method disclosed in Non Patent Literature 1, for example.

Specifically, the search unit 240 groups the output candidates by the number of tokens of the constraint satisfied by the candidates at each processing time j, holds a predetermined number of candidates from a sequence having a high generation probability in each group, and executes the search. This makes it possible to obtain the most probable output sequence under the condition that the constraint vocabulary is necessarily included.

The search unit 240 performing a search using grid beam search is an example. Any processing method may be used as long as it is the processing method in which the constrained search is performed so as to include the constraint vocabulary.

### <Correction Unit 250 of Generation Apparatus 200>

The correction unit 250 corrects the output sequence (also referred to as an output sentence) output from the search unit 240 so that a portion indicating the constraint vocabulary in the translation sentence is not inconsistent with a portion given as the constraint vocabulary. The details are as follows.

Due to pre-processing or the like, in the middle of processing the constraint vocabulary into a form that is easy to input into the machine translation model, information regarding a blank may be dropped, or the encoding of a multibyte character may be handled differently from the original encoding. In addition, a word that cannot be handled in the machine translation model may be replaced with a special character. In this case, when the processed “constraint vocabulary” is input into the machine translation model, inconsistency may occur between the input “constraint vocabulary” and the originally given constraint vocabulary.

Then, a perfect match search using the original constrained vocabulary in the output sequence may no longer match, resulting in an output sequence that does not include the original constraint vocabulary.

Such a problem is not limited to the configuration of “input generation unit 220+sequence conversion unit 230+search unit 240” of the present embodiment, and is a problem that can occur in general conventional lexically constrained machine translation models.

In order to solve the above problem, the correction unit 250 performs correction processing on the connected output sequence.

Specifically, the correction unit 250 holds the original output sequence (uncorrected output sentence) and the original constraint vocabulary. For example, the correction unit 250 corrects the original output sequence with the original constraint vocabulary when matching based on the constraint vocabulary subjected to the normalization processing succeeds with respect to the sequence subjected to the normalization processing with respect to the original output sequence. Examples of normalization processing are listed as follows. However, the following is an example and is not limited to the following.

### (1) Normalization Related to Character System Factor

The normalization related to a character system factor is, for example, normalization with respect to multibyte characters. For example, in a case where a full-width symbol or the like is expressed in 16 decimal digits, the full-width symbol or the like is corrected to correct notation that is not 16 decimal digits. In this case, a language of a multibyte character such as Japanese or Chinese is a processing target, and only an output sequence is normalized. However, there may be a case where normalization is performed on the constraint vocabulary.

### (2) Normalization of Tokenizer Factor

In the normalization of a tokenizer factor, for example, spaces before and after symbols are deleted. That is, in the case of the tokenization, a space is formed before and after a symbol such as a hyphen, and thus, the space is deleted. This is general-purpose normalization processing, and only the output sequence is normalized. However, there may be a case where normalization is performed on the constraint vocabulary.

### (3) Normalization of Predetermined Character Factor

The predetermined character in the normalization of a predetermined character factor is, for example, a blank. For example, with respect to a constraint vocabulary that is a simple perfect match and does not match from the translation sentence, a search is performed again in a state where a full-width/half-width blank is ignored, and a matching place is replaced with the notation of the original constraint vocabulary. This is general-purpose normalization processing.

Both the constraint and the output sentence are subjected to normalization (for example, full-width and half-width spaces are ignored in both) to perform matching, and the character range of the original output sentence corresponding to the character string range of the matched output sentence is replaced with the original constraint vocabulary.

### (4) Normalization of Unknown Word Factor

In a case where a word (unknown word, OOV) that is not handled by the machine translation model is included, the model outputs a special token “??”. Therefore, in consideration of this, substring in the constraint vocabulary is replaced with the special token, and a portion that completely matches this is replaced with the original constraint vocabulary. For example, with respect to a constraint vocabulary of “multiple lacunar infarction case”, “multiple lacunar?? case” is created, and a search is performed using the created constraint vocabulary.

The special token “??” is an example, and may be any token as long as it is a token indicating that it is an unknown word for the model.

Here, a procedure example in a case where (4) described above is performed assuming the configuration of FIG. 4 will be described below.

S10: The lexically constrained sequence generation unit 270 outputs a sentence including “??” as an output sentence. For example, “This case was multiple lacunar?? case” is output. Even if the output sentence is searched using the multiple lacunar infarction case that is the constraint vocabulary, the output sentence does not match.

S20: Assuming that the output sentence includes the character string of the constraint vocabulary, the correction unit 250 performs processing of searching for the multiple lacunar infarction case that is the constraint vocabulary. Specifically, the following S20-1 and S20-2 are performed.

S20-1: The correction unit 250 sets a character string in which any portion of a constraint vocabulary has been converted into ?? as a query to search for an output sentence including ??. For example, the search is performed for each of multiple lacunar?? case, multiple?? infarct case, lacunar infarction case, . . . . The search is performed for character strings in which replacement is performed with ?? in all possible patterns.

S20-2: When a matching query is found, the correction unit 250 replaces the matched character range in the output sentence with the original constraint vocabulary (in the example described above, a multiple lacunar infarction case).

With the processing described above, it is possible to obtain an output sentence in which it can be confirmed that the 100% constraint vocabulary is included by the search based on a perfect match.

Among the processes (1) to (4) described above, for example, (1) is performed first, and then (2), (3), and (4) are performed in order. However, this is an example, and at least one of the processes (1) to (4) may be performed in any order.

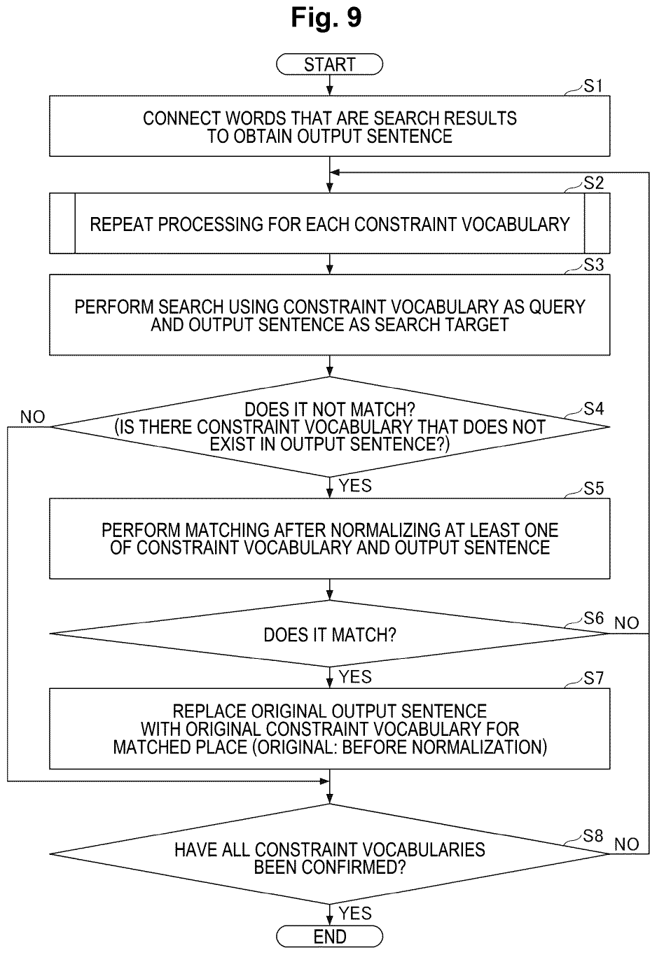

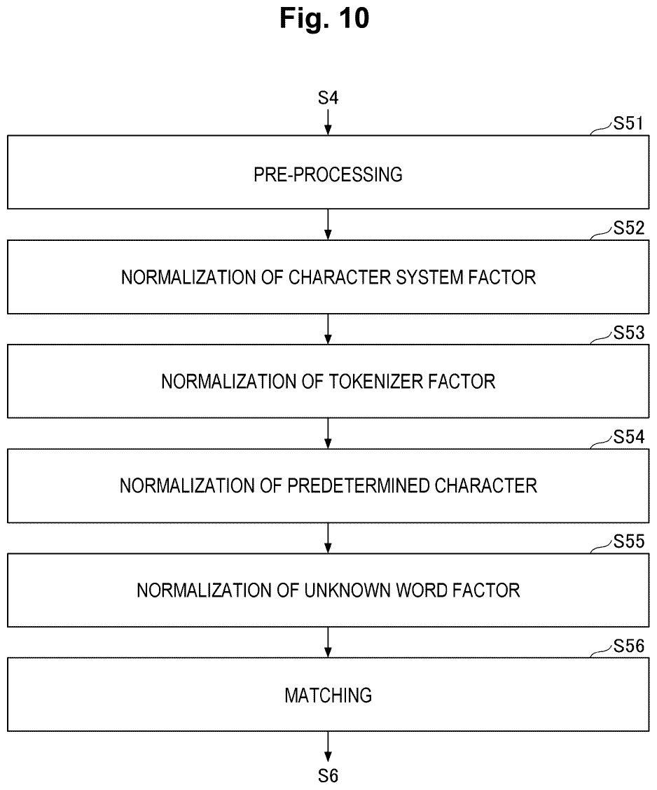

An example of a processing procedure of the correction unit 250 will be described with reference to the flowcharts of FIGS. 9 and 10.

In S1 of FIG. 9, the correction unit 250 connects words that are search results received from the search unit 240 to obtain an output sentence.

The correction unit 250 repeats the processing of S3 to S8 for each constraint vocabulary (S2). In S3, the correction unit 250 performs a search using the constraint vocabulary as a query and the output sentence as a search target.

In S4, the correction unit 250 determines whether the queries do not match (whether there is a constraint vocabulary that does not exist in the output sentence). When the determination in S4 is Yes (no match), the process proceeds to S5, and when the determination in S4 is No, the process proceeds to S8.

In S5, the correction unit 250 performs matching after normalizing at least one of the constraint vocabulary and the output sentence. That is, after normalization, a search is performed with the constraint vocabulary as a query and the output sentence as a search target.

In S6, the correction unit 250 determines whether there is a match. When the determination in S6 is No, the process returns to S2, and the processing is performed with the next constraint vocabulary.

When the determination in S6 is Yes, the process proceeds to S7. In S7, the correction unit 250 replaces the original output sentence (the output sentence before normalization) with the original constraint vocabulary (the constraint vocabulary before normalization) for the matched place.

In S8, when the confirmation of all the constraint vocabularies has been completed, the process ends. If confirmation of all the constraint vocabularies has not been completed, the processing from S2 is performed on the next constraint vocabulary.

Next, details of the processing of S5 in FIG. 9 will be described with reference to FIG. 10.

In S51, as pre-processing, the correction unit 250 copies the original constraint vocabulary to create the matching constraint vocabulary, and copies the original output sentence to create the output sentence for matching. The correction unit 250 performs the following normalization processing and matching on the matching constraint vocabulary or the output sentence for matching. The normalization processing corresponds to (1) to (4) described above.

In S52, the correction unit 250 normalizes the character system factor. Specifically, for example, the multibyte character is normalized with respect to the output sentence for matching. The normalization of the multibyte character is, for example, to correct a full-width symbol in 16 decimal notation.

In S53, the correction unit 250 normalizes the tokenizer factor. For example, the correction unit 250 deletes blanks before and after symbols from the output sentence for matching.

In S54, the correction unit 250 normalizes the predetermined character. Specifically, for example, the correction unit 250 performs processing of deleting a blank (full-width/half-width) from the constraint vocabulary for matching and the output sentence for matching.

In S55, the correction unit 250 normalizes the unknown word factor. For example, the correction unit 250 creates a result obtained by replacing the substring in the constraint vocabulary for matching with a special token. Since there are a plurality of types of special tokens and a plurality of places are assumed for replacement, a replacement for each of the plurality of special tokens is created, and matching with the output sentence is performed in a brute-force manner in S56. In S56, the correction unit 250 performs matching.

The procedure of FIG. 10 is an example. For example, the search (matching) for the output sentence using the constraint vocabulary may be performed every time each step of S52 to S55 is performed. In this case, the constraint vocabulary for matching and the output sentence for matching may be initialized (the original may be copied) each time the matching fails, or the next step normalization may be performed while maintaining the normalization result of the preceding stage.

However, the possibility of successfully matching the constraint vocabulary that does not match the output sentence due to a plurality of factors can be increased by performing matching after performing all normalization.

S52 to S56 may not necessarily be in this order. However, by performing the processing in this order, the accuracy of matching of unknown words can be further improved.

### (Experimental Result)

An experiment was performed using the generation apparatus 200 according to the present embodiment. In the following description of experimental results, “the generation apparatus 200 according to the present embodiment” is referred to as a proposed system.

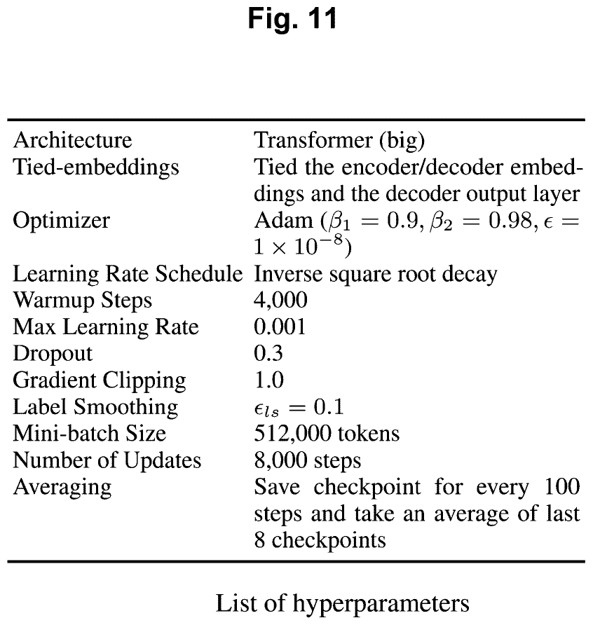

FIG. 11 illustrates detailed settings and hyperparameters serving as a base in each setting used in an experiment. FIG. 11 merely illustrates an example of detailed settings and hyperparameters.

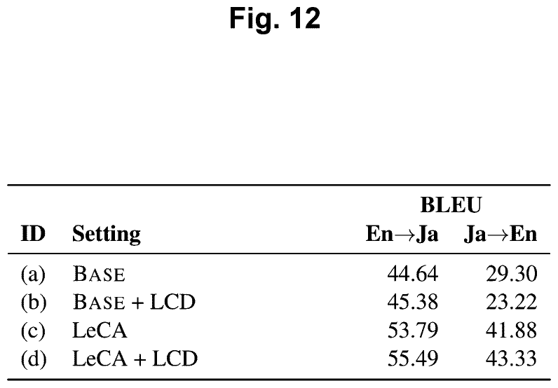

FIG. 12 illustrates evaluation results (BLUE scores for both English-Japanese and Japanese-English) of each setting. (a) BASE indicates an evaluation result when a general transformer model is used. (b) BASE+LCD illustrates an evaluation result using a model called lexically constrained decoding (LCD) using grid beam search disclosed in Non Patent Literature 1 “Post and Vilar (2018) proposed a grid beam search decoding. They guarantee to satisfy all constraints.”.

(c) LeCA illustrates evaluation results using a model called lexical-constraint-aware (LeCA) NMT disclosed in Reference Document “Chen et al. (2020) proposed a method that augment the input of the translation model.” (d) LeCA+LCD indicates the evaluation result of the proposed system. As illustrated in FIG. 12, the most preferable evaluation result is obtained by the proposed system.

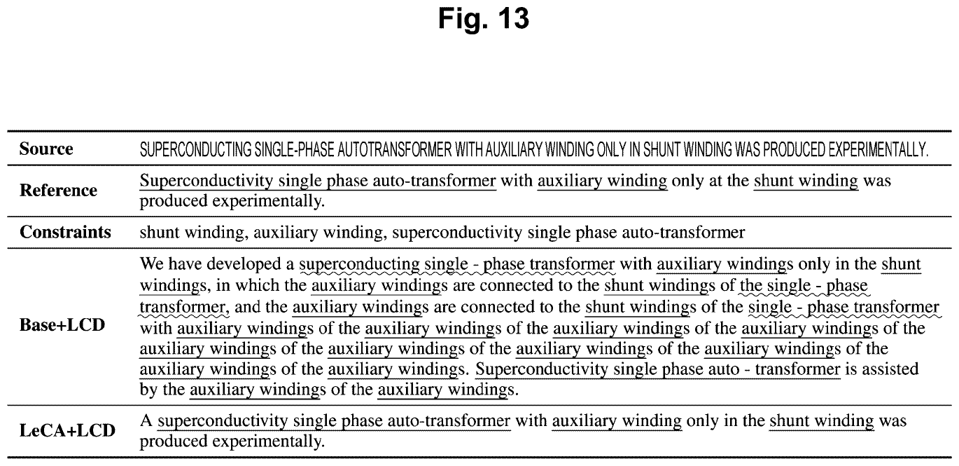

FIG. 13 illustrates an example of a translation sentence based on the model “Base+LCD” and a translation sentence based on the proposed system “LeCD+LCD”. In FIG. 13, “Source” indicates a source language sentence, “Reference” indicates a correct translation sentence, and “Constraints” indicates a constraint vocabulary.

Underlined portions in FIG. 13 indicate portions matching the constraint vocabulary. As illustrated in FIG. 13, the translation sentence generated by the “Base+LCD” model has all the constraint vocabularies, but the same phrase is repeatedly generated and translation is not successful.

On the other hand, the proposed system successfully generates a translation sentence including a constraint vocabulary. The reason is that the LeCA model of the proposed system gives a higher score to the constraint vocabulary than the case of the model of “Base+LCD”, so that a sentence including the constraint vocabulary can be generated.

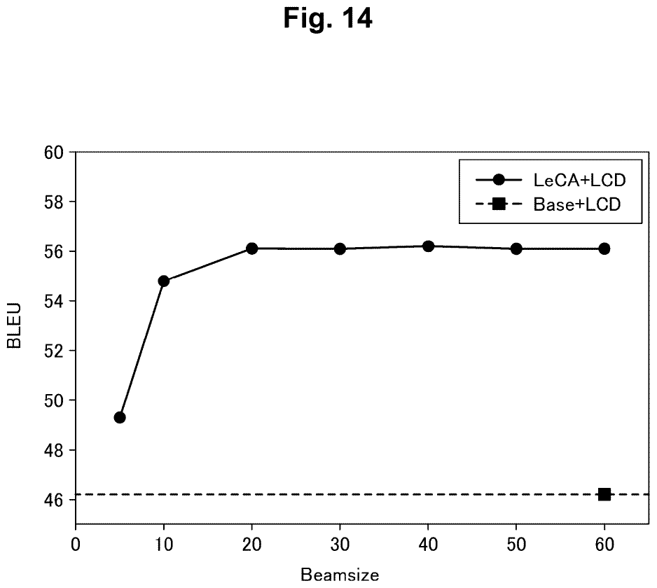

FIG. 14 illustrates the BLEU scores of the English-Japanese translation when various beam sizes are used for each of the “Base+LCD” model and the proposed system. In the “Base+LCD” model, a beam size larger than 60 is necessary to generate the translation sentence so as to include all the constraint vocabularies. On the other hand, the proposed system can accurately generate the translation sentence including all the constraint vocabularies even if the beam size is small.

That is, in the proposed system, the search time can be shortened, and the translation accuracy can be improved as is clear from the experimental result.

The experiment confirmed that 100% of the constraint vocabulary can be included in the translation sentence by performing the above-described normalization correction in the proposed system. That is, in the experiment, when the correction by normalization is not performed, only about 94% of the constraint vocabulary is included in the form of perfect match, but 100% of the constraint vocabulary can be included by performing the correction by normalization.

In the proposed system that performs correction by normalization, the BLUE of the translation sentence and the BLUE of the translation after the replacement in which the part not including the constraint vocabulary in the form of perfect match is replaced with an empty string have been compared. As a result, it has been confirmed that there is almost no difference between the BLUE of the translation sentence and the BLUE of the translation sentence after the replacement. This also shows that all the constraint vocabularies are included in the translation sentence.

### (Hardware Configuration Example)

Any device (learning device 100, generation apparatus 200) described in the present embodiment can be implemented by causing a computer to execute a program, for example. This computer may be a physical computer, or may be a virtual machine on a cloud.

That is, the device can be implemented by a program corresponding to processing performed by the device being executed by use of hardware resources such as a CPU and a memory built in the computer. The above program can be stored and distributed by being recorded in a computer-readable recording medium (portable memory or the like). The above program can also be provided through a network such as the Internet or an electronic mail.

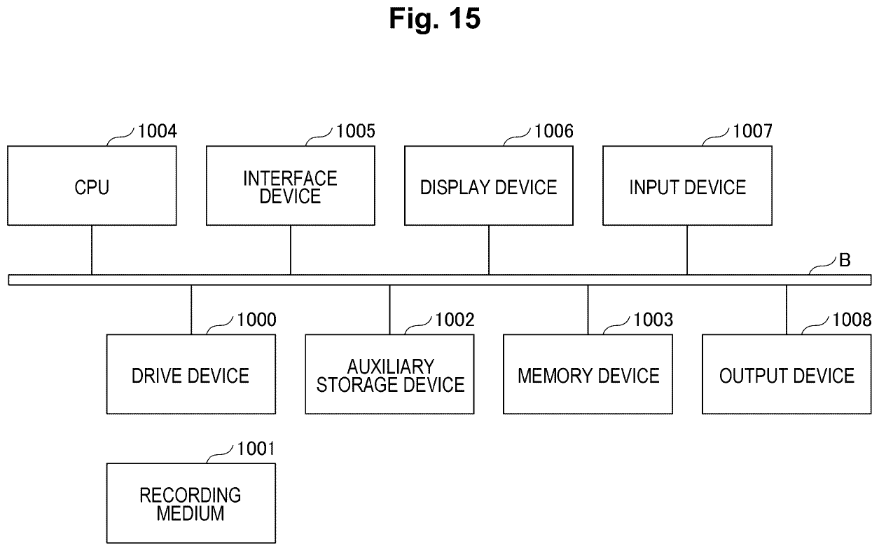

FIG. 15 is a diagram illustrating an example hardware configuration of the computer. The computer in FIG. 15 includes a drive device 1000, an auxiliary storage device 1002, a memory device 1003, a CPU 1004, an interface device 1005, a display device 1006, an input device 1007, and an output device 1008, which are connected to one another by a bus BS. The computer may further include a GPU.

The program for implementing the processing in the computer is provided by a recording medium 1001 such as a CD-ROM or a memory card. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program, and also stores necessary files, data, and the like.

When an instruction to start the program is made, the memory device 1003 reads the program from the auxiliary storage device 1002 and stores the program. The CPU 1004 implements a function related to a light touch retaining device 100 according to the program stored in the memory device 1003. The interface device 1005 is used as an interface for connection to a network or the like. The display device 1006 displays a graphical user interface (GUI) or the like according to the program. The input device 1007 includes a keyboard and a mouse, buttons, a touch panel, or the like, and is used to input various operation instructions. The output device 1008 outputs a calculation result.

### Effects and Like of Embodiment

As described above, in the present embodiment, the input information is extended in accordance with the constraint vocabulary for the lexically constrained machine translation, the extended information is input to the machine translation model, and the grid beam search that ensures that all the constraint vocabularies are included is performed for the output from the machine translation model. This makes it possible to generate a translation sentence including all the constraint vocabularies in a short search time. By appropriately correcting the output sentence, for example, even when there is an unknown word or the like in the constraint vocabulary, a translation sentence that completely satisfies the constraint can be generated.

In summary, the generation apparatus 200 illustrated in FIG. 3 applies the grid beam search to the output from the model to which the series obtained by connecting the source language sentence and the constraint vocabulary is input, so that the search time is shortened and the processing speed is improved. Furthermore, as can be seen from the experimental results, the translation accuracy is improved.

Since the output sentence is corrected by the generation apparatus 200 illustrated in FIG. 4 with reference to the information of the original notation before processing the data such as the constraint vocabulary, for example, even when an input with missing information is used as an input to the model, all the given constraint vocabularies are included in the output sentence. This effect is also obtained by the generation apparatus 200 illustrated in FIG. 2.

Regarding the above embodiment, the following supplementary notes 1 and 2 are further disclosed.

### <Supplement 1>

### (Supplementary Note 1)

A generation apparatus that generates an output sequence that is a sequence of another piece of information from an input sequence that is a sequence of information, the generation apparatus including:
a memory; and
at least one processor connected to the memory,
in which the processor
generates an input sequence with constraint information on the basis of the input sequence and constraint information,
generates output information by inputting the input sequence with constraint information to a sequence conversion model, and
generates the output sequence by performing a constrained search using the output information such that the output sequence includes the constraint information.

### (Supplementary Note 2)

The generation apparatus according to supplementary note 1,
in which the processor corrects the output sequence obtained by the search unit such that the constraint information matches by searching the output sequence.

### (Supplementary Note 3)

The generation apparatus according to supplementary note 2,
in which the processor replaces a matched part with original control information that is not processed when the constraint information matches the output sequence from the search unit after normalization on at least one of the output sequence and the constraint information is performed.

### (Supplementary Note 4)

A generation method performed by a computer that generates an output sequence that is a sequence of another piece of information from an input sequence that is a sequence of information, the generation method including:
generating an input sequence with constraint information on the basis of the input sequence and constraint information;
generating output information by inputting the input sequence with constraint information to a sequence conversion model; and
generating the output sequence by performing a constrained search using the output information such that the output sequence includes the constraint information.

### (Supplementary Note 5)

A non-transitory storage medium storing a program for causing a computer to function as the generation apparatus according to any one of supplementary notes 1 to 3.

### <Supplement 2>

### (Supplementary Note 1)

A generation apparatus that generates an output sequence that is a sequence of another piece of information from an input sequence that is a sequence of information, the generation apparatus including:
a memory; and
at least one processor connected to the memory,
in which the processor
generates the output sequence from the input sequence and constraint information given, by using a sequence conversion model, and
corrects the output sequence so that the output sequence includes the constraint information.

### (Supplementary Note 2)

The generation apparatus according to supplementary note 1,
in which the processor sets the constraint information as a query, performs normalization on at least one of the output sequence from the generation unit and the query, searches the output sequence using the query, and replaces a part matched with the query in the output sequence with original constraint information corresponding to the query and not subjected to processing of the normalization.

### (Supplementary Note 3)

The generation apparatus according to supplementary note 2,
in which the processor performs at least one of normalization of a character system factor, normalization of a tokenizer factor, normalization of a predetermined character, and normalization of an unknown word factor as the normalization.

### (Supplementary Note 4)

The generation method performed by a computer that generates an output sequence that is a sequence of another piece of information from an input sequence that is a sequence of information, the generation method including:
generating the output sequence from the input sequence and constraint information given, by using a sequence conversion model; and
correcting the output sequence so that the output sequence includes the constraint information.

### (Supplementary Note 5)

A non-transitory storage medium storing a program for causing a computer to function as the generation apparatus according to any one of supplementary notes 1 to 3.

While the present embodiments have been described above, the present invention is not limited to such specific embodiments, and various modifications and changes can be made within the scope of the spirit of the present invention described in the claims.

### REFERENCE SIGNS LIST

100 Learning device
110 Parallel translation sentence data DB
120 Input unit
130 Lexical constraint generation unit
140 Input/output generation unit
150 Learning data DB
160 Model learning unit
170 Output unit
200 Generation apparatus
210 Input unit
220 Input generation unit
230 Sequence conversion unit
240 Search unit
250 Correction unit
260 Output unit
270 Lexically constrained sequence generation unit
1000 Drive device
1001 Recording medium
1002 Auxiliary storage device
1003 Memory device
1004 CPU
1005 Interface device
1006 Display device
1007 Input device
1008 Output device

1. A generation apparatus that generates an output sequence that is a sequence of another piece of information from an input sequence that is a sequence of information, the generation apparatus comprising:
a processor; and
a memory that includes instructions, which when executed, cause the processor to execute:
generating the output sequence from the input sequence and constraint information given, by using a sequence conversion model; and
correcting the output sequence obtained by the generating so that the output sequence includes the constraint information.

2. The generation apparatus according to claim 1,
wherein the correcting includes setting the constraint information as a query, performing normalization on at least one of the generated output sequence or the query, searching the output sequence using the query, and replacing a part matched with the query in the output sequence with original constraint information corresponding to the query and not subjected to processing of the normalization.

3. The generation apparatus according to claim 2,
wherein the correcting includes performing at least one of normalization of a character system factor, normalization of a tokenizer factor, normalization of a predetermined character, or normalization of an unknown word factor as the normalization.

4. A generation method performed by a computer that generates an output sequence that is a sequence of another piece of information from an input sequence that is a sequence of information, the generation method comprising:
generating the output sequence from the input sequence and constraint information given, by using a sequence conversion model; and
correcting the output sequence so that the output sequence includes the constraint information.

5. A non-transitory computer-readable recording medium having computer-readable instructions stored thereon, which when executed, cause a computer that generates an output sequence that is a sequence of another piece of information from an input sequence that is a sequence of information, the computer including a memory and a processor, to execute:
generating the output sequence from the input sequence and constraint information given, by using a sequence conversion model; and
correcting the output sequence so that the output sequence includes the constraint information.
